(19) United States
(12) Patent Application Publication
(10) Pub. No.: US 2002/0166341 A1
(43) Pub. Date: Nov. 14, 2002

(54) Technique for quartz crucible fabrication having reduced bubble content in the wall

(76) Inventors: Robert D. Shelley, Chesterland, OH (US); Victor L. K. Lou, Schenectady, NY (US)

Correspondence Address: Scott A. McCollister, FAY, SHARPE, FAGAN, MINNICH & McKEE, LLP, 7th Floor, 1100 Superior Avenue, Cleveland, OH, 44114-2518, US

(21) Appl. No.: 10/139,564

(22) Filed: May 3, 2002

Related U.S. Application Data
(63) Continuation of application No. 08/847,975, filed on Apr. 21, 1997, now abandoned.
Application No. 08/847,975 is a continuation of application No. 08/339,539, filed on Nov. 15, 1994, now abandoned.

(51) Int. Cl. C03B 19/09; C03B 20/00

(52) U.S. Cl. 65/17.3; 65/32.1; 65/22

(57) ABSTRACT

A method for fabricating fused quartz crucibles is disclosed. Quartz sand is placed in a rotating fusion pot and takes on the shape of a bowl as a result of centrifugal forces. The quartz sand is heated to a temperature sufficient to melt and fuse the quartz sand together. A fast diffusing gas such as helium or hydrogen is passed through the quartz sand to displace residual gases present in voids defined by the quartz sand. The fast diffusing gas remains present in the voids. The resulting crucible has reduced bubble growth during use as well as reduced bubble count and bubble size at fusion.

### BACKGROUND OF THE INVENTION

The present invention is directed to fused quartz crucibles and to a method of manufacturing fused quartz crucibles useful in the semiconductor industry for growing single crystal silicon from polycrystalline silicon according to the Czochralski process.

Crucibles used for preparing single crystal silicon for the semiconductor industry should be free from impurities as well as included bubbles or other structural imperfections in order to maintain a desired crystal orientation in the silicon growing process. In addressing the need for reducing bubble content in crucibles, the inventors in Patent No. 4,416,680 describe a process of introducing a raw material quartz into a rotating hollow mold which has gas pervious wall regions at the side walls and bottom thereof. After introducing the raw material into the mold, a heat source such as an electric arc is introduced into the mold which causes the quartz to melt. Simultaneously with the heating, a vacuum is applied to the outside of the mold during continued rotation to draw out any interstitial gases, with an aim toward collapsing the voids. The vacuum is maintained during melting and rotation. Thereafter, the finished crucible may be ejected by replacing the vacuum with compressed air outside the mold. This method is used throughout the industry for preparing fused quartz crucibles.

Although the specification of the 4,416,680 patent indicates that the crucible walls made according to the described process are bubble free, they are not. It has been discovered that minute air or gas bubbles, comprised mainly of nitrogen and oxygen, are trapped in voids defined in the crucible walls. As the crucibles are subjected to vacuum and high temperatures during single crystal silicon growth, the nitrogen and oxygen expand, forming larger and larger bubbles. These expanding bubbles can cause fragmentation of the inner crucible wall and interrupt single crystal growth.

More specifically, when the crucibles are in use for growing single crystal silicon, polycrystalline silica is present inside the crucible bowl in a melted state. The molten silicon reacts with the fused quartz wall to the extent that a small amount of the inner wall, on the order of approximately 1 mm, is dissolved. If the crucible wall which dissolves contains bubbles, the dissolution process can cause the material surrounding the bubble to fragment. In so doing, fine chips of fused quartz may be released. These chips can destroy the single crystal orientation, thus limiting the crystal growing yield.

The small air bubbles present in crucible wall voids do not always cause problems in single crystal silicon growth. For example, when crucibles having a smaller diameter are used in connection with single crystal silicon growth, the temperatures to which the crucible must be exposed for maintaining a melt are lower than the temperatures required for larger diameter crucibles. As crucible diameter increases, temperatures increase along with the time of exposure to these temperatures. These time and temperature factors contribute significantly to the growth of bubbles within the crucible wall.

The issue of bubbles in crucible walls may be addressed in one of two ways. One way calls for eliminating bubbles from the crucible walls entirely. A second way calls for preventing bubbles from growing upon exposure to high temperatures. The present inventors have addressed the latter approach and developed a method for improving fused quartz crucibles by preventing or reducing bubble growth in the crucible walls during high temperature application. They have also reduced the overall bubble count and bubble size at fusion. Other attempts at alleviating bubbles are discussed in U.S. Pat. Nos. 4,935,046 and 4,956,208. The method described in these patents calls for depositing a layer of SiCl₄ on the crucible surface by chemical vapor deposition. This method, though quite effective at eliminating bubbles, is costly to pursue as it requires significant equipment outlays. Because fused quartz crucibles are used in large quantities, it is important to keep the manufacture of them as economical as possible. The inventors of the present invention have developed an economical way to reduce bubble growth and reduce bubble count and size in crucible walls during application of high temperatures.

### SUMMARY OF THE INVENTION

The present invention contemplates a method of fused quartz crucible manufacture which overcomes all of the above referenced problems and others and provides for a crucible having reduced bubble content, reduced bubble size and reduced bubble growth, attributes which are particularly beneficial during use of the crucible during high temperature applications.

According to the practice of the subject invention, quartz sand grains are deposited in a rotating fusion pot and subjected to centrifugal forces to form a bowl-shape. Heat is applied to fuse the sand grains together. A fast diffusing gas such as helium or hydrogen is flushed through the grains to displace any residual gases from the walls. The resulting fused quartz crucible comprises a base extending upwardly into a continuous wall comprised of fused quartz grains. The gases trapped in the interstices between the sand grains in the wall define a bubble or void content of up to about 0.05%, with a typical size of the bubbles being less than about 0.0025 inches, preferably less than about 0.0020 inches, and even more preferably less than about 0.0015 inches. During high temperature application of the crucible, bubble growth is reduced over that of the prior art. The voids or bubbles contain a high content of helium or hydrogen gas.

A principal advantage the invention is the reduction in bubble growth in the walls of fused quartz crucibles during their use in crystal pulling.

Another advantage of the present invention is the significant and economical reduction in bubble count and size in the walls of fused quartz crucibles.

Other advantages and benefits of the present invention will become apparent to those skilled in the art upon a reading and understanding of the following detailed description.

### BRIEF DESCRIPTION OF THE DRAWINGS

The invention may take physical form in certain parts and arrangements of parts, a preferred embodiment of which will be described in detail in this specification and illustrated in the accompanying drawing which forms a part hereof.

FIG. 1 is a schematic representation of an apparatus suitable for carrying out the method of the subject invention, and illustrates an apparatus adapted for making fused quartz crucibles used for growing silicon ingots in the semiconductor industry.

### DETAILED DESCRIPTION OF THE PREFERRED EMBODIMENT

Fused quartz crucibles are used by the semiconductor industry for growing single crystal silicon ingots from polycrystalline silicon according to the Czochralski process. In conducting the Czochralski process or crystal growing process, polycrystalline silicon is placed in a quartz crucible and melted down at temperatures above 1420° C. The resulting melt is touched with a seed crystal. As the crystal is pulled out, a single crystal silicon ingot grows.

During ingot growth, the molten silicon reacts with the fused quartz crucible to the extent that roughly 1 mm of the crucible inside wall is dissolved. If the crucible wall which dissolves contains bubbles, the dissolution process can cause the material surrounding the bubble to fragment. In so doing, fine chips or fragments of fused quartz may be released from the crucible wall. Fragments which break off may cause multiple crystal orientations if they contact the growing ingot, thus limiting the crystal growing yield.

The crucible is fabricated by pouring pure quartz sand or granulated fused silica into a rotating graphite fusion pot. Centrifugal forces cause the sand to hold to the sides of the pot, taking on the shape of a bowl. An electric arc causes the crucible wall to reach a sufficient temperature to cause a rapid fusion of the sand grains. A series of openings at the bottom of the graphite pot supply a vacuum to remove or reduce any residual gases which are liberated during fusion.

Not all gases between the sand grains are removed by the vacuum. The sand grains typically fuse together too quickly, trapping gases in the voids. The gases roughly parallel the composition of air, being primarily high in nitrogen and oxygen content. Nitrogen is present at around 80%, followed by oxygen at around 18%. Small amounts of argon (up to about 1%) may also be present, along with residual carbon dioxide (approximately 1%) due to the presence of the graphite electrodes.

The gases in the voids which are present in the crucible wall will expand upon subsequent exposure to high temperatures and low vacuum conditions used during single crystal silicon growth. This causes undesirable bubble formation and/or bubble growth to occur.

The present inventors have determined that bubble size and count can be significantly reduced by fusing quartz crucibles in a helium or hydrogen environment rather than in an air environment. The technique makes use of the existing arc fusion process but provides a means whereby residual gases (primarily nitrogen and oxygen) initially present between the sand grains are replaced by helium or hydrogen. That is, instead of fusing in an air environment as taught by the prior art, helium or hydrogen is used to flush out these environmental gases. Initially, this flushing of helium or hydrogen diffuses through the sand and escapes. With the start of fusion, a skin forms on the inside of the sand later forming a seal. At this point, the helium or hydrogen is forced to flow through the sand grains, flushing gases and filling the voids between the sand grains. When fused, the crucible wall has a substantially lower bubble count and bubble size because some of the helium has escaped by diffusion during the fusion process. During subsequent use in the crystal puller, there is much less bubble growth compared with conventional or prior art crucibles because of favorable conditions for helium or hydrogen to continue to diffuse out of the crucible wall.

In conventional crucibles where helium or hydrogen is not present, voids in the crucible wall are filled with gases such as nitrogen, oxygen and argon. Fusion in the presence of such gases produces an opaque material with poor bubble structure, leaving more than 2% voids by volume. These gases trapped in the voids are immobile and insoluble, leaving stable voids which cannot be fined. Helium and hydrogen, on the other hand, are more mobile. For example, helium has a diffusivity five orders of magnitude higher than nitrogen, and a solubility much higher than nitrogen. Helium or hydrogen which is trapped in the voids or pores can diffuse out of the walls during crucible use, thus causing the voids to collapse.

The principles of this invention are more effective when applied to large diameter crucibles because of the longer times and higher temperatures to which large crucibles are subjected as compared to small diameter crucibles. This longer time and higher temperature exposure promotes bubble growth and adversely affects the single crystal silicon growth process.

It is also foreseeable that these crucibles may be used in a recharge process. Crucibles used in recharge are subjected to high temperatures for a time period almost double that of a single charge. Therefore, there is a greater potential for bubble fragmentation.

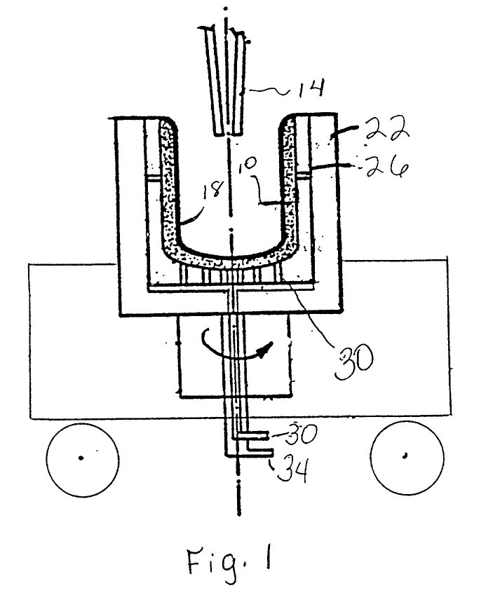

FIG. 1 schematically illustrates an apparatus which may be used in fabricating a fused quartz crucible in accordance with the method of the present invention. The figure shows quartz sand grains 10 which have been poured into a rotating graphite fusion pot. Centrifugal forces cause the sand to hold to the sides of the pot, taking on the shape of a bowl. Heat is applied to the sand grains via electrodes 14 of an electric arc, thus melting and fusing the sand together to form a crucible 18. The electric arc causes the crucible wall to reach a sufficient temperature to cause rapid fusion of the sand grains. The fusing crucible sits in a rotating housing 22 into which helium or hydrogen is introduced. Several uniformly spaced ports 26 permit the helium or hydrogen present in the housing to pass through the quartz sand. Once the crucible inner wall forms a “skin”, the helium or hydrogen can displace the other gases present in the voids. A series of openings or ports 30 at the bottom of the graphite pot supply a vacuum creating a helium or hydrogen flow to remove any residual gases from between the sand. The sand grains fuse together, producing a crucible with low bubble size, lower bubble count, and the voids filled with helium or hydrogen. Helium or hydrogen is introduced to the housing via helium inlet 34.

### EXAMPLES

A study was conducted to show the improved results achieved by replacing the air, nitrogen, oxygen, argon and carbon dioxide gases present in the crucible wall voids with helium. The crucibles were subjected to a temperature of 1500° C., under 4.5 Torr vacuum for times of 19 and 49.5 hours. Microscopic studies of the bubbles were made to determine representative or typical bubble diameters. The results are quantified in the following table:

| | | AFTER 19 | | AFTER 49.5 | |
|---|---|---|---|---|---|
| | REPRESENTATIVE | HR. VACUUM | | HR. VACUUM | |
| | DIAMETER AS | BAKE | BUBBLE | BAKE | BUBBLE |
| CRUCIBLE | FUSED (INCHES) | (INCHES) | GROWTH | (INCHES) | GROWTH |
| Prior Art | .0025 | .0050 | 2X | .0068 | 2.7X |
| He-Flushed | .0015 | .0017 | 1.1X | .0018 | 1.2X |

The above results show that bubble size is reduced by flushing helium through the fusing crucible. After subjecting the crucibles to a vacuum bake for 19 hours and 49.5 hours, the helium-flushed crucible showed only a slight bubble growth as compared to the prior art non-helium-flushed crucible. The slight bubble growth occurred because helium flushing was not 100% effective in that because residual gases other than helium remained in the bubbles.

The effect of this slight bubble growth was further investigated: Three samples, fused in various helium-nitrogen mixtures of 100% helium, 90% helium—10% nitrogen, and 67% helium—33% nitrogen, were subjected to vacuum bake at 1730° C., 60 minutes and 5 Torr of argon. The sample fused in 100% helium remained completely bubble-free, the sample fused in 10% nitrogen—90% helium was still transparent but developed some 0.2 mm size bubbles, and the sample fused in 33% nitrogen—67% helium became opaque with many 0.5 mm bubbles. Higher opacity signifies a greater bubble count.

This invention has been described with reference to a preferred embodiment. Obviously, modifications and alterations will occur to others upon a reading and understanding of the specification. It is intended to include all such modifications and alterations insofar as they come within the scope of the appended claims or the equivalents thereof.

What we claim as new and desire to secure by Letters Patent of the United States is:

1. A method for manufacturing a fused quartz crucible, comprising the steps of:
rotating a fusion pot containing quartz sand such that centrifugal forces cause the quartz sand to take on the shape of a bowl having a base and a continuous side wall;
heating the quartz sand to a temperature sufficient to melt and fuse the quartz sand together; and
introducing helium into the quartz sand to displace residual gases present in voids defined by the quartz sand.

2. A method for manufacturing a fused quartz crucible, according to claim 1, comprising the additional step of:
forming a skin layer on an interior surface of the side wall for displacing residual gases present in the voids with helium.

3. A method for manufacturing a fused quartz crucible, according to claim 1, comprising the additional step of:
applying a vacuum at the bottom of the fusion pot to create a helium flow to remove residual gases from between the quartz sand.

4. A method for manufacturing a fused quartz crucible, according to claim 1, comprising the additional steps of:
fusing the quartz sand together; and
maintaining helium in the voids defined by the fused quartz sand.

5. A method for manufacturing a fused quartz crucible, according to claim 1, comprising the additional step of:
producing a fused quartz crucible having a void content of up to about 0.05%, said voids containing primarily helium.

6. A method for manufacturing a fused quartz crucible, according to claim 1, comprising the additional step of:
producing a fused quartz crucible having a representative bubble size of less than about 0.0025 inches.

7. A fused quartz crucible, comprising:
a base extending upwardly into a continuous side wall comprised of fused quartz grains, said fused quartz grains defining bubbles adjacent an inner surface of the wall, said bubbles containing helium gas.

8. A fused quartz crucible, according to claim 7, wherein helium present in the bubbles escapes during high temperature application of the crucible, thereby reducing fragmentation of the crucible wall inner surface during crucible use.

9. A fused quartz crucible, according to claim 7, wherein the helium present in the bubbles escapes during high temperature application of the crucible, thereby reducing bubble growth during crucible use.

10. A fused quartz crucible, according to claim 8, wherein the high temperature application involves exposing the crucible to a temperature at least as high as a melting point of polycrystalline silicon.

11. A fused quartz crucible, according to claim 7, wherein a representative size of a helium-containing bubble adjacent the inner surface of the wall is less than about 0.0025 inches.

12. A fused quartz crucible, according to claim 7, wherein said fused quartz grains define a void content of up to about 0.05%.

13. A fused quartz crucibles according to claim 7, wherein the crucible is used in a recharge process.

14. A method of using a fused quartz crucible in growing single crystal silicon, comprising the steps of:
providing a crucible comprising a base extending upwardly into a continuous side wall comprised of fused quartz grains which define helium-containing bubbles;
subjecting the crucible to temperatures sufficiently high to melt polycrystalline silicon in the crucible; and
subsequently limiting bubble size expansion to a factor of up to about 1.2.

15. A method of using a fused quartz crucible in growing single crystal silicon, according to claim 14, wherein a representative bubble size of the crucible that is provided is less than 0.0025 inches.

16. A method of using a fused quartz crucible in growing single crystal silicon, according to claim 14, wherein a void content in the crucible that is provided is about 0.05%.

17. A method for manufacturing a fused quartz crucible, comprising the steps of:
rotating a fusion pot containing quartz sand such that centrifugal forces cause the quartz sand to take on the shape of a bowl having a base and a continuous side wall;
heating the quartz sand to a temperature sufficient to melt and fuse the quartz sand together; and
introducing fast diffusing gas into the quartz sand to displace residual gases present in voids defined by the quartz sand.

18. A method for manufacturing a fused quartz crucible, according to claim 17, wherein the fast diffusing gas is helium.

19. A method for manufacturing a fused quartz crucible, according to claim 17, wherein the fast diffusing gas is hydrogen.

20. A fused quartz crucible comprising:
a base extending upwardly into a continuous side wall comprised of fused quartz grains, said fused quartz grains defining bubbles adjacent an inner surface of the wall, said bubbles containing a fast diffusing gas.

21. A fused quartz crucible according to claim 20, wherein the fast diffusing gas is helium.

22. A fused quartz crucible according to claim 20, wherein the fast diffusing gas is hydrogen.

23. A method for manufacturing a fused quartz crucible, comprising the steps of:
rotating a fusion pot containing quartz sand such that centrifugal forces cause the quartz sand to take on the shape of a bowl having a base and a continuous side wall;
heating the quartz sand to a temperature sufficient to melt and fuse the quartz sand together; and
introducing hydrogen into the quartz sand to displace residual gases present in voids defined by the quartz sand.

24. A fused quartz crucible comprising:
a base extending upwardly into a continuous side wall comprised of fused quartz grains, said fused quartz grains defining bubbles adjacent an inner surface of the wall, said bubbles containing helium.
